(19) United States
(12) Patent Application Publication
(10) Pub. No.: US 2016/0077801 A1
(43) Pub. Date: Mar. 17, 2016

(54) METHOD AND SYSTEM FOR OBTAINING DYNAMIC DISTRIBUTED DATA OF SAMPLE ATTRIBUTES

(71) Applicant: Tencent Technology (Shenzhen) Company Limited., Shenzhen (CN)

(72) Inventors: Shangliang Zhang, Shenzhen (CN); Xuxin Wang, Shenzhen (CN)

(21) Appl. No.: 14/949,312

(22) Filed: Nov. 23, 2015

Related U.S. Application Data
(63) Continuation of application No. PCT/CN2014/079232, filed on Jun. 5, 2014.

(30) Foreign Application Priority Data
Aug. 13, 2013 (CN) 201310351587.6

(51) Int. Cl. G06F 7/36; G06F 17/30

(52) U.S. Cl. CPC G06F 7/36; G06F 17/30386

(57) ABSTRACT

A method for obtaining dynamic distributed data of sample attributes includes: obtaining a sample attribute from any one sample out of a pool of large-scale samples; determining an updated location of where the obtained sample attribute is located within a priorly-maintained sample attribute queue, and then performing updating at the updated location utilizing the obtained sample attribute; maintaining an orderly arrangement of the sample attributes in the sample attribute queue, in order to obtain dynamic distributed data of the obtained sample attributes, wherein: the sample attribute queue stores the sample attributes of the pool of large-scale samples, the sample attributes are orderly arranged in the sample attribute queue; a length of the sample attribute queue is set at a value of N, wherein the value N being smaller than a total number of the samples in the pool of large-scale samples. The method reduces dynamic distributed data sample attributes calculations.

### CROSS-REFERENCE TO RELATED APPLICATIONS

The application is a continuation of PCT Application No. PCT/CN2014/079232, filed on Jun. 5, 2014, which claims priority to Chinese Patent Application No. 2013103515876, filed on Aug. 13, 2013, which are incorporated by reference in their entireties.

### FIELD OF THE TECHNOLOGY

The present disclosure generally relates to data processing technology, especially relates to a method and a system for obtaining dynamic distributed data of sample attributes.

### BACKGROUND

Sample attributes refer to dynamic attribute having statistical value. For examples: in mobile communication, user's mobile terminal may be a sample, and the sample attribute may be the traffic on the user's mobile terminal; in agriculture, poultry and forestry cultivation studies, chicken, ducks and pigs may be samples, and the sample attribute may be the sample weight; for on-line gaming, each on-line game player may be a sample and the sample attribute may be the fighting capacity or resource of the corresponding on-line game player.

Nowadays, obtaining statistics data on these samples have increasingly difficult because such data collection may be considered as collecting dynamic distributed data of sample attributes from a pool of large-scale samples. More specifically, the data of sample attributes may be varying dynamically and distributed over a large sample size.

Sample status or sample condition, however, may be known intuitively if dynamic distributed data of sample attributes may be obtained. For example, knowing the usage status of each user's mobile terminals traffic in a certain area may provide intuitive guidance for channel optimization in base station construction. In poultry and agriculture studies, knowing poultry's weight may affect cultivation strategy, etc.

At present, sample attribute of each sample from a pool of large-scale samples may generally be updated and then stored in a database on a regular basis. A server may traverse the database regularly to read sample attribute of all the samples (i.e., a pool of large-scale samples) in the database in order to obtain dynamic distributed data of sample attributes. The inventor discovers that the existing technologies have at least the following technical issues: sample attributes of all the samples in the database need to be traversed in order to obtain the dynamic distributed data of sample attributes. Therefore, a time consuming and intensive computations may be needed.

### SUMMARY

Different embodiments of the present disclosure may provide a system and method for obtaining dynamic distributed data of sample attributes to solve the above technical problems discussed in the background.

An aspect of the present disclosure provides a method for obtaining dynamic distributed data of sample attributes, including: obtaining a sample attribute from any one sample out of a pool of large-scale samples; determining an updated location of where the obtained sample attribute may be located within a priorly-maintained sample attribute queue, and then performing updating at the updated location utilizing the obtained sample attribute; maintaining an orderly arrangement of the sample attributes in the sample attribute queue, in order to obtain dynamic distributed data of the obtained sample attributes, wherein: the sample attribute queue stores the sample attributes of the pool of large-scale samples, the sample attributes are orderly arranged in the sample attribute queue; a length of the sample attribute queue may be set at a value of N, wherein the value N may be smaller than a total number of the samples in the pool of large-scale samples.

Another aspect of the present disclosure may provide a system for obtaining dynamic distributed data of sample attributes, which includes at least a processor with circuitry operating in conjunction with at least a memory which stores instruction codes operable as plurality of modules, wherein the plurality of modules may include: an obtaining module which obtains a sample attribute from any one sample out of a pool of large-scale samples; a location update determining module, which determines an updated location of where the obtained sample attribute may be located within a priorly-maintained sample attribute queue; an updating module which updates at the updated location utilizing the obtained sample attribute; an order-maintaining module which maintains an orderly arrangement of the sample attributes in the sample attribute queue, in order to obtain dynamic distributed data of the obtained sample attributes, wherein: the sample attribute queue stores the sample attributes of the pool of large-scale samples, the sample attributes are orderly arranged in the sample attribute queue; a length of the sample attribute queue may be set at a value of N, wherein the value N may be smaller than a total number of the samples in the pool of large-scale samples.

Yet another embodiment discloses a non-transitory computer readable storage medium, wherein the computer readable storage medium stores a program which comprises codes or instructions to cause a machine to obtain dynamic distributed data of sample attributes, the operations may include: obtaining a sample attribute from any one sample out of a pool of large-scale samples; determining an updated location of where the obtained sample attribute may be located within a priorly-maintained sample attribute queue, and then performing updating at the updated location utilizing the obtained sample attribute; maintaining an orderly arrangement of the sample attributes in the sample attribute queue, in order to obtain dynamic distributed data of the obtained sample attributes, wherein: the sample attribute queue stores the sample attributes of the pool of large-scale samples, the sample attributes are orderly arranged in the sample attribute queue; a length of the sample attribute queue may be set at a value of N, wherein the value N may be smaller than a total number of the samples in the pool of large-scale samples.

The method and system or obtaining dynamic distributed data of sample attributes according to the present disclosure may be based on a principle of simple random sampling and a principle which samples an overall pool of large-scale samples which follow a same distribution. That is, the sample attribute's distribution may be reflected by a sample attribute queue, which includes N samples that may be sampled from the pool of large-scale samples, as being the same as the sample attributes' distribution reflected by the overall pool of large-scale samples. Thus, the sample attribute's distribution of the overall pool of large-scale samples may be reflected by the sample attribute's distribution of the sample attribute queue.

On such basis, the present disclosure keeps an ordered arrangement sample attribute queue with a length of N which may be smaller than the total number of samples in the pool of large-scale samples. A specific implementation may be: obtaining a sample attribute of any one from a pool of large-scale samples, determining the updated location of the obtained sample attribute in the pre-maintained sample attribute queue, and then updating with the obtained sample attribute in the updated location. An orderly arrangement of the sample attributes in the sample attribute queue may be maintained in order to obtain the dynamic distributed data of sample attributes which reflect sample attribute's distribution of the pool of large-scale samples.

Current disclosure may be based on a simple random sampling principle, rather than having to traverse the database to read all sample attributes as in the current technology. Current disclosure discloses a method and a system which obtains dynamic distributed data of the sample attributes, only if the sample attribute queue having a length of N may be maintained, thereby substantially reducing the calculations for obtaining the dynamic distributed data of the sample attributes.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 may be a flowchart of an exemplary method for obtaining dynamic distributed data of sample attributes, according to an embodiment of the present disclosure.

FIG. 2 illustrates an exemplary sample attribute queue structure, according to an embodiment of the present disclosure.

FIG. 3 may be a flowchart of an exemplary method for obtaining dynamic distributed data of sample attributes, according to another embodiment of the present disclosure.

FIG. 4 may be a flowchart of an exemplary method for obtaining dynamic distributed data of sample attributes, according to another embodiment of the present disclosure.

FIG. 5 may be a flowchart of an exemplary method for obtaining dynamic distributed data of sample attributes, according to another embodiment of the present disclosure.

FIG. 6 shows a data graph illustrating on-line game players' fighting capacity queue in an on-line game.

FIG. 7 shows another data graph illustrating on-line game players' fighting capacity queue in an on-line game.

FIG. 8 illustrates an exemplary system for obtaining dynamic distributed data of sample attributes, according to an embodiment of the present disclosure.

FIG. 9 shows an exemplary structure of a location update determining module, according to an embodiment of the present disclosure.

FIG. 10 shows an exemplary structure of an updating module, according to an embodiment of the present disclosure.

FIG. 11 shows an exemplary structure of an order-maintaining module, according to an embodiment of the present disclosure.

FIG. 12 shows an exemplary structure of a second determining unit, according to an embodiment of the present disclosure.

FIG. 13 shows an exemplary structure of an updating module, according to another embodiment of the present disclosure.

FIG. 14 shows an exemplary structure of an order-maintaining module, according to another embodiment of the present disclosure.

FIG. 15 shows an exemplary structure of an updating module, according to another embodiment of the present disclosure.

FIG. 16 shows an exemplary structure of an order-maintaining module, according to another embodiment of the present disclosure.

FIG. 17 shows an exemplary hardware structure of a server, according to one embodiment of the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing or referenced ahead to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, but not to limit the present disclosure.

FIG. 1 may be a flowchart of an exemplary method for obtaining dynamic distributed data of sample attributes, according to an embodiment of the present disclosure. In an embodiment, if the method may be implemented in a server, the server may acquire dynamic distributed data of sample attributes by data sampling processing, as shown in FIG. 1. The method may include at least the following exemplary steps:

Step 100: obtaining a sample attribute from any one sample out of a pool of large-scale samples. More specifically, any one sample out of a pool of large-scale samples which has gone through a change may be sent to a server as the obtained sample attribute from the pool of large-scale samples.

Preferably, this embodiment may also send the sample attribute of every sample which may be in a participation mode from the pool of large-scale samples to the server as the obtained sample attribute from the pool of large-scale samples. It may be pointed out that the participation mode may change from application to application.

For example, if the sample may be a mobile terminal, the sample attribute may be the corresponding mobile terminal traffic. The mode may refer to a log in mode of the mobile terminal traffic in an instant messaging software application. The mobile terminal may send a traffic state of the logging in to the instant messaging software to the server.

As another example, if the sample may be an on-line game player, the sample attribute may be the corresponding fighting capacity of the on-line game player. The mode may refer to the playing strategy or the fighting approach adopted by all the players who may be involved in in the same on-line game. Accordingly, the fighting capacity of each player who adopts the same strategy in the same on-line game may be sent as the obtained sample attribute to the server.

Preferably, data uploaded to the server along with the sample attribute may also include a sample ID to correspond to the sample attribute. For example, assuming that the mobile traffic may be the sample attribute which may be uploaded to the server, the mobile ID may be utilized as a sample ID to correspond to the mobile traffic. Yet in another example, assuming that the fighting capacity uploaded to the server may be the sample attribute, the player ID may be utilized as the sample ID to correspond to the fighting capacity of the corresponding on-line game player.

Step 110: determining an updated location where the obtained sample attribute may be located within a priorly-maintained sample attribute queue, and then performing updating at the updated location utilizing the obtained sample attribute.

In this embodiment, the server may maintain in advance a sample attribute queue storing the sample attributes of all the samples in a pool of large-scale samples. The sample attribute may be orderly arranged from the biggest to the smallest or from the smallest to the biggest, vice versa. The length of the sample attribute queue may be set at a value of N, and N may be smaller than the total number of samples in the pool of large-scale samples. In other words, the sample attribute queue being N stored in the total number of samples may be smaller than the total number of samples in the pool of large-scale samples.

In an embodiment, the sample attribute queue may store the sample attribute and the corresponding sample ID. Since the sample ID may be arranged to identify the corresponding sample, thus the sample ID may identify the samples to which the sample attribute in the sample attribute queue may belong.

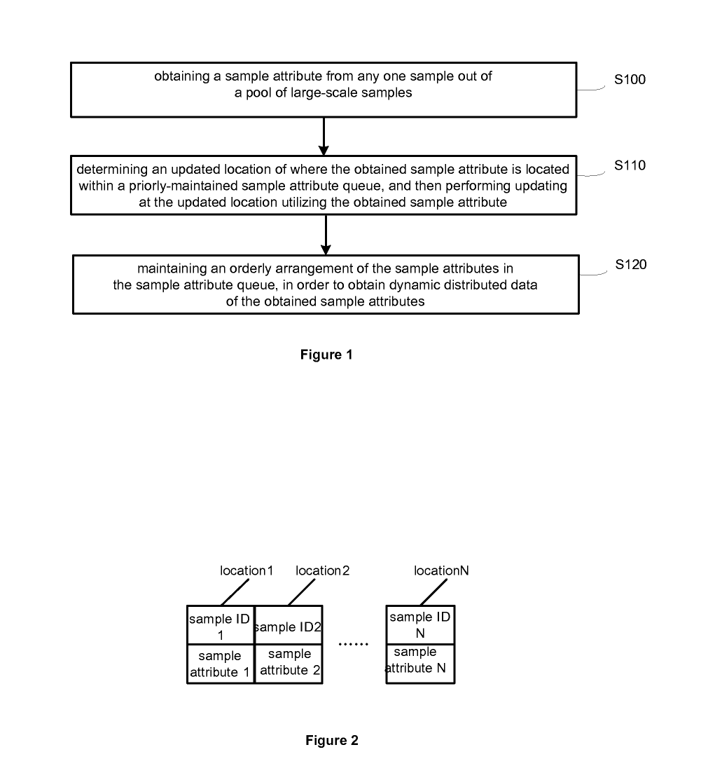

To illustrate the sample attribute queue, refer to FIG. 2 which shows an exemplary structure of the sample attribute queue. As seen in FIG. 2, the sample attribute queue may have N locations, and every location may store a sample attribute and a corresponding sample ID. More specifically, location 1 may store sample attribute 1 and the corresponding sample ID1, location 2 may store sample attribute 2 and the corresponding sample ID2, and so on. It may be worth noting that, while updating the obtained sample attribute into the updated location, the corresponding sample ID at the location may need to be updated as well.

Step 120: maintaining an orderly arrangement of the sample attributes in the sample attribute queue, in order to obtain dynamic distributed data of the obtained sample attributes. In this embodiment, the updated location may refer to the location which the obtained sample attribute was written into in the sample attribute queue.

It may be worth noting that the updated location may be the only written location in the sample attribute queue of the obtained sample attribute, instead of the final location in the sample attribute queue of obtained sample attribute. It may be because the sample attribute of sample attribute queue should maintain an orderly arrangement, so that if the sample attribute of sample attribute queue may be not orderly arranged after the obtained sample attribute has been written into the updated location, there may be a need to adjust the location of sample attribute in the sample attribute queue, in order to get the final dynamic distributed data of the sample attributes. if the sample attribute of the sample attribute queue may be arranged orderly after the obtained sample attribute has been written into updated location, it may not be necessary to adjust the location of sample attribute in the sample attribute queue again, since the sample attribute queue that has been written in the obtained sample attribute may be able to reflect the final dynamic distributed data of sample attributes.

The method for obtaining the dynamic distributed data of sample attributes provided in this embodiment may be based on a principle of simple random sampling and according to a principle that samples and the overall pool of large-scale samples which follow the same distribution. In other words, the sample attribute's distribution reflected by the sample attribute queue may include N samples that may be sampled from the pool of large-scale samples, and the distribution may be the same as the sample attribute's distribution as reflected by the overall pool of large-scale samples. Hence, the sample attribute's distribution of the overall pool of large-scale samples may be reflected by the sample attribute's distribution of the sample attribute queue.

With the above understanding in mind, the present disclosure may keep an orderly-arrangement sample attribute queue with a length of N which may be smaller than the total number in the pool of large-scale samples. The following may be an exemplary implementation: obtaining a sample attribute from any one sample out of a pool of large-scale samples; determining an updated location of where the obtained sample attribute is located within a priorly-maintained sample attribute queue, and then performing updating at the updated location utilizing the obtained sample attribute; maintaining an orderly arrangement of the sample attributes in the sample attribute queue, in order to obtain dynamic distributed data of the obtained sample attributes, wherein: the sample attribute queue stores the sample attributes of the pool of large-scale samples, the sample attributes are orderly arranged in the sample attribute queue; a length of the sample attribute queue is set at a value of N, wherein the value N is smaller than a total number of the samples in the pool of large-scale samples.

In this embodiment of the disclosure, there may be three conditions which stipulate the relationship between the obtained sample attribute and the sample attribute queue. The first condition being: there may be an old sample attribute already stored in the sample attribute queue for the corresponding sample of obtained sample attribute. Thus the old sample attribute stored in the sample attribute queue may be updated with the obtained sample attribute. The second condition being: there may not be an old sample attribute stored in the sample attribute queue for the corresponding sample of obtained sample attribute and the length of sample attribute queue has not exceeded a set value of N, thus insert the obtained sample attribute into the sample attribute queue to lengthen the sample attribute queue, while maintaining the sample attribute in an orderly arrangement in the sample attribute queue until the length of sample attribute queue reaches the set value of N. The third condition being: there may not be an old sample attribute stored in the sample attribute queue for the corresponding sample of obtained sample attribute and the length of sample attribute queue has reached the set value of N, then choose a sample attribute whose magnitude may be similar to the magnitude of the obtained sample attribute from the sample attribute queue and replace the chosen sample attribute with the obtained sample attribute.

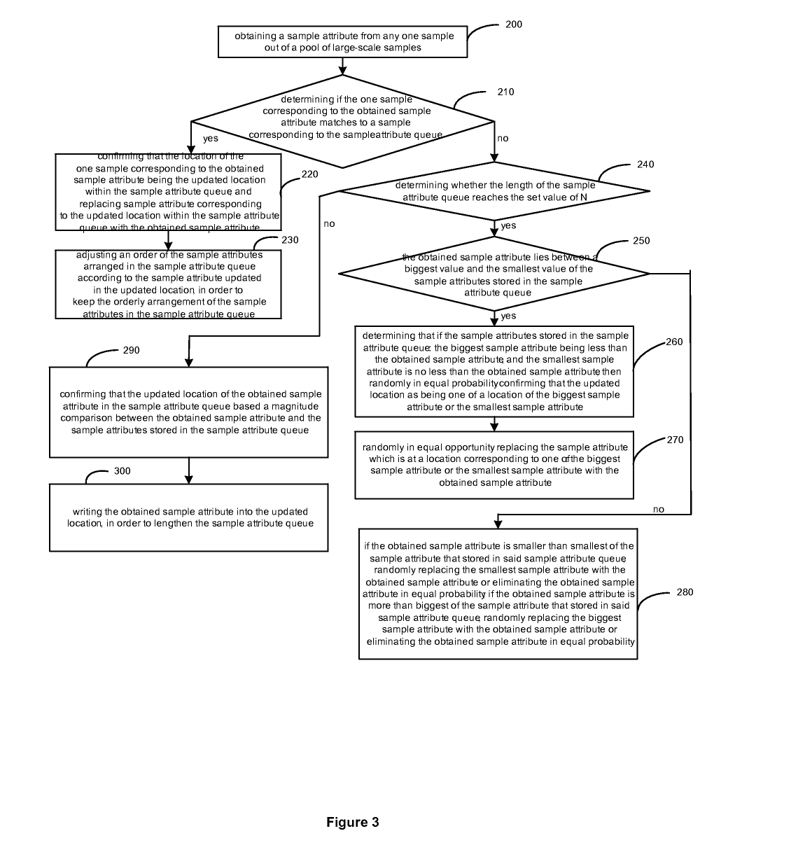

FIG. 3 may be a flowchart of an exemplary method for obtaining dynamic distributed data of sample attributes, according to another embodiment of the present disclosure. The method may include the following exemplary operations:

Step 200: obtaining a sample attribute from any one sample out of a pool of large-scale samples. Preferably, the data obtained along with the sample attribute may also include the corresponding sample ID.

Step 210: determining if the one sample corresponding to the obtained sample attribute matches to a sample corresponding to the sample attribute queue. If the result may be yes, then executing step 220, if the result may be no, then executing step 240.

Preferably, the sample attributes queue stores the sample attribute and the corresponding sample ID. The embodiment of step 210 may be as follows: determining whether the sample ID corresponding to the obtained sample attribute matches the sample ID corresponding to the priorly-maintained sample attribute queue, if the result may be yes, then it may be certain that the sample corresponding to the obtained sample attribute matches the sample corresponding to the priorly-maintained sample attribute queue, which means that there may be an old sample attribute stored in the sample attribute queue for the corresponding sample of obtained sample attribute; if the result may be no, then it may be certain that the sample corresponding to the obtained sample attribute does not match the sample corresponding to the priorly-maintained sample attribute queue, which means that there may be not an old sample attribute stored in the sample attribute queue for the corresponding sample of obtained sample attribute.

Step 220: confirming that the location of the one sample corresponding to the obtained sample attribute being the updated location within the sample attribute queue, and replacing sample attribute corresponding to the updated location within the sample attribute queue with the obtained sample attribute.

Because the sample attribute queue stores the old sample attribute of the sample corresponding to the obtained sample attribute, the updated location referred by step 220 may be the corresponding location of the old sample attribute, which means that the location of sample corresponding to the obtained sample attribute may be the location where the old sample attribute of sample corresponding to the obtained sample attribute may be stored.

Assuming that the obtained sample attribute may be D, wherein: an−2, an−1, an and an+1 may respectively be the sample attributes in the sample attribute queue. If the corresponding sample of D may be the same as the corresponding sample of an, this may mean that the sample ID uploaded to server along with D may be the same as the corresponding sample ID of an stored in the sample attribute queue, and the location in the sample attribute queue of an may be the updated location of D. Accordingly, the sample attribute an may be replaced with D at the location of an.

It may be worth noting that, while replacing the old sample attribute with the obtained sample attribute at the updated location, it may be necessary to replace the corresponding old sample ID with the corresponding sample ID of obtained sample attribute at the updated location.

Step 230: adjusting an order of the sample attributes arranged in the sample attribute queue according to the sample attribute updated in the updated location, in order to keep the orderly arrangement of the sample attributes in the sample attribute queue.

Step 220 only replaces the old sample attribute with the obtained sample attribute at the updated location. However, there is no certainty that the sample attribute queue may maintain an orderly arrangement. Therefore, it may be necessary to adjust the order of sample attribute in the sample attribute queue according to the magnitude of sample attribute in order to keep the sample attribute in the sample attribute queue orderly arranged.

In an implementation, it may be preferable to compare the updated sample attribute at an update position (i.e. the obtained sample attribute) with other sample attribute in the sample attribute queue, in order to maintain an orderly arrangement of the sample attribute in the sample attribute queue according to the comparison result.

Step 240: determining if the length of the sample attribute queue reaches the set value of N; if the result may be yes, then executing step 250, if the result may be no, then executing step 290.

Step 250: determining if the obtained sample attribute lies between the biggest and the smallest value of the sample attribute stored in the sample attribute queue. If the result may be yes, then executing step 260, if the result may be no, then executing step 280.

Step 260: determining that if the sample attributes stored in the sample attribute queue: the biggest sample attribute being less than the obtained sample attribute, and the smallest sample attribute is no less than the obtained sample attribute, then randomly in equal probability, confirming that the updated location as being one of: a location of the biggest sample attribute or the smallest sample attribute.

Since the length of the sample attribute queue may reach the set value of N, and the obtained sample attribute may be not smaller than some sample attribute that are stored in the sample attribute queue, it may be necessary to be certain that the obtained sample attribute may replace some sample attributes that are stored in the sample attribute queue.

Assuming that the obtained sample attribute may be: D, an−2, an−1, an and an+1, respectively, as the sample attributes in the sample attribute queue; if an−1<D<=an, then an−1 may be the biggest sample attribute which may be smaller than the obtained sample attribute in the sample attribute queue, and an may be the smallest sample attribute which may be not smaller than the obtained sample attribute in the sample attribute queue, then randomly in equal opportunity, determining the location of an−1 or an as the updated location so as to replace an−1 or an with D in equal probability.

Step 270: randomly in equal opportunity, replacing the sample attribute at the location corresponding to one of: the biggest sample attribute or the smallest sample attribute with the obtained sample attribute. Afterwards, the sample attributes may be orderly arranged in the sample attribute queue.

It may be worth noting that, while randomly in equal opportunity, replacing the sample attribute at the location corresponding to one of: the biggest sample attribute or the location of smallest sample attribute with the obtained sample attribute, it may also be necessary to replace the sample ID of biggest sample attribute or smallest sample attribute corresponding to the sample ID of the obtained sample attribute.

It may be worth noting that, this embodiment may not always replace the biggest sample attribute an−1 (which may be smaller than D) with D. In case if the biggest sample attribute an−1 (which may be smaller than D) is always replaced with D, the queue may be the list of the highest sample attribute.

Likewise, this embodiment may not always replace the smallest sample attribute an (which may be more than D) with D. In case if the smallest sample attribute an (which may be more than D) is always replaced with D, the queue may be the list of the lowest sample attribute. The disclosure therefore randomly in equal opportunity, replaces an−1 or an with D, and such principle may cause the sample attribute queue to reflect the distribution of an overall pool of large-scale samples more accurately.

Preferably, a binary search method may be used to compare the magnitude of obtained sample attribute with the magnitude of sample attribute in the queue, and to identify the biggest sample attribute and the smallest sample attribute.

Step 280: if the obtained sample attribute may be smaller than the smallest of the sample attribute that stored in the sample attribute queue, randomly in equal opportunity, replacing the smallest sample attribute with the obtained sample attribute or deleting the obtained sample attribute; if the obtained sample attribute may be more than maximum of the sample attribute that stored in the sample attribute queue, randomly in equal opportunity, replacing the biggest sample attribute with the obtained sample attribute or deleting the obtained sample attribute.

If assuming that the obtained sample attribute may be D, and the minimum of the sample attribute that may be stored in the sample attribute queue may be a0, if D<a0, then this embodiment may randomly replace a0 with D or deleting D in equal probability, and the sample attribute queue at this time may be regarded as orderly. If assuming that the maximum of the sample attribute that stored in the sample attribute queue may be an, if D>an, then this embodiment may randomly replace an with D or deleting D in equal probability, and the sample attribute queue at this time may be regarded as orderly.

Step 290: confirming that the updated location of the obtained sample attribute in the sample attribute queue based a magnitude comparison between the obtained sample attribute and the sample attributes stored in the sample attribute queue.

Step 300: writing the obtained sample attribute into the updated location, in order to lengthen the sample attribute queue; afterwards, the sample attribute of the sample attribute queue may be considered orderly arranged.

Since the length of the sample attribute queue may not exceed the set value of N, the obtained sample attribute may be inserted into the updated location to lengthen sample attribute queue until the length of the sample attribute queue reaches N.

If assuming that the obtained sample attribute may be D, an−2, an−1, an and an+1 may be the sample attribute in the sample attribute queue. If D may be a median of the sample attribute queue (i.e., D may be between an−1 and an), then D may be inserted between an−1 and an. If D may be the maximum of sample attribute queue, then D may be inserted into the head of sample attribute queue (the head may be the location where the biggest sample attribute stored in sample attribute queue). If D may be the minimum of sample attribute queue, then D may be inserted into the end of sample attribute queue (the end may be the location where the smallest sample attribute stored in sample attribute queue). That means that the sample attribute queue may add a location in this embodiment, and store D at this location in order to lengthen sample attribute queue until the length of the sample attribute queue reaches N.

A binary search method may be used to compare the magnitude of obtained sample attribute with the magnitude of sample attribute in the queue. It may be worth noting that, while updating the obtained sample attribute into the updated location to lengthen sample attribute queue, this embodiment may also update the corresponding sample ID into the updated location.

As shown in FIG. 3, it may be seen that the method for obtaining the dynamic distributed data of sample attributes may also be a determination of an updated location as follows.

If it may be determined that the one sample corresponding to the obtained sample attribute matches to a sample corresponding to the sample attribute queue, confirming that the location of the one sample corresponding to the obtained sample attribute being the updated location within the sample attribute queue;

If the sample corresponding to the obtained sample attribute does not match the sample corresponding to the sample attribute queue, determining the updated location of the obtained sample attribute by comparing a magnitude of the obtained sample attribute to each magnitude of the sample attributes stored in the sample attribute queue. The condition may be divided into the following four conditions.

If the length of the sample attribute queue reaches the set value of N, and if the obtained sample attribute lies between a maximum value and a minimum value of the sample attributes stored in the sample attribute queue: determining that if the sample attributes stored in the sample attribute queue: the biggest sample attribute being less than the obtained sample attribute, but the smallest sample attribute being no less than the obtained sample attribute, then randomly in equal probability, confirming that the updated location as being one of: a location of the biggest sample attribute or the smallest sample attribute.

If the length of the sample attribute queue reaches the set value of N, and if the obtained sample attribute being smaller than the smallest sample attributes stored in the sample attribute queue, then randomly in equal opportunity, performing one of: replacing the smallest sample attribute with the obtained sample attribute, otherwise, deleting the obtained sample attribute.

If the length of the sample attribute queue reaches the set value of N, and if the obtained sample attribute being greater than the biggest sample attributes stored in the sample attribute queue, then randomly in equal opportunity, performing one of: confirming that a location of the sample attributes with the maximum value as the updated location, otherwise, deleting the obtained sample attribute.

If the length of the sample attribute queue fails to reach the set value of N, then confirming that the updated location of the obtained sample attribute in the sample attribute queue based a magnitude comparison between the obtained sample attribute and the sample attributes stored in the sample attribute queue.

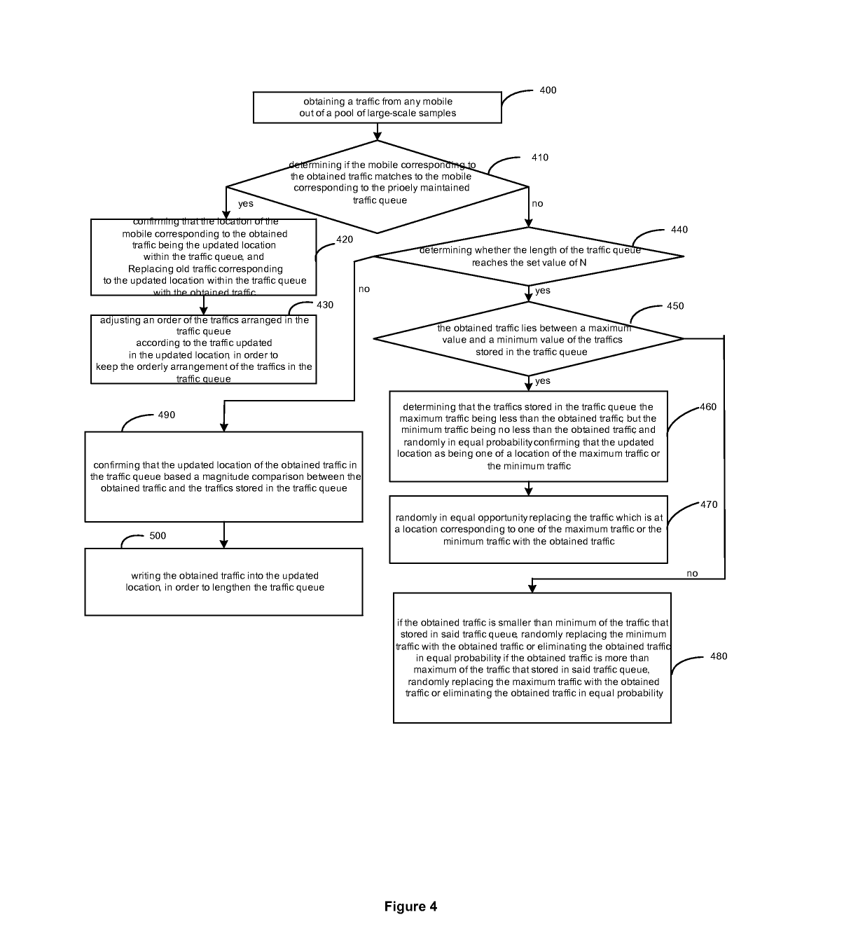

Another implementation of the method for obtaining the dynamic distributed data of sample attributes provided by this disclosure may be illustrated by an example involving users' mobile terminals traffic, as illustrated in FIG. 4.

More specifically, FIG. 4 illustrates a flowchart of an exemplary method for obtaining dynamic distributed data of sample attributes in mobile terminal traffic, wherein the sample attribute may be the mobile terminal traffic, any one sample may be a mobile terminal, a pool of large scale data may be the mobile terminals in an area, and the sample attribute queue may be the traffic queue. The method may include the following exemplary steps.

Step 400: obtaining the traffic of any mobile terminal in one area. To illustrate this embodiment, mobile terminal traffic changes may be sent to a server. Some mobile terminals pertaining to one area or to a base station may be engaged in a surfing mode may be sent to the server. For example, when mobile terminals log into instant messaging software utilizing mobile traffic, the mobile terminals may be under a state of logging in to instant messaging software and send the traffic to the server. Data may be uploaded to the server along with the traffic which may also include a mobile ID (such as mobile number).

Step 410: determining if the mobile terminal corresponding to the obtained traffic matches to a mobile terminal corresponding to the priorly-maintaining traffic queue, if the result may be yes, then executing step 420, if the result may be no, then executing step 440. Wherein, the traffic queue stores the traffic of the mobile terminals in the area, and the length of the traffic queue may be N which may be smaller than the total number of the mobile terminals in this area. The traffic may be arranged orderly in the traffic queue from the heaviest to the lightest, or vice versa.

Preferably, the traffic queue may store the mobile traffic and the corresponding mobile ID. One may compare the mobile ID stored in the traffic queue with the mobile ID of the obtained traffic. If the result may be yes, it may be certain that the mobile terminal corresponding to the obtained traffic may match the mobile terminal corresponding to the priorly-maintained traffic queue, and there may be old traffic stored in the traffic queue for the corresponding mobile of obtained traffic. If the result may be no, then it may be certain that the mobile terminal corresponding to the obtained traffic does not match the mobile terminal corresponding to the priorly-maintained traffic queue, and there may not be old traffic stored in the traffic queue for the corresponding sample of obtained traffic.

Step 420: confirming that the location of the mobile terminal corresponds to the obtained traffic being the updated location within the traffic queue, and replacing old traffic corresponding to the updated location within the traffic queue with the obtained traffic.

Step 430: adjusting an order of the traffics arranged in the traffic queue according to the traffic updated in the updated location, in order to keep the orderly arrangement of the traffics in the traffic queue.

Step 440: determining if the length of the traffic queue reaches a set value of N; if the result may be yes, then executing step 450, if the result may be no, then executing step 490.

Step 450: determining if the obtained traffic lies between the maximum and minimum of the traffic that stored in the traffic queue; if the result may be yes, then executing step 460, if the result may be no, then executing step 480.

Step 460: determining that the traffics stored in the traffic queue: the maximum traffic being less than the obtained traffic, but the minimum traffic being no less than the obtained traffic, and randomly in equal probability, confirming that the updated location as being one of: a location of the maximum traffic or the minimum traffic.

Step 470: randomly in equal opportunity, replacing the traffic which is at the location corresponding to one of: the maximum traffic or the minimum traffic with the obtained traffic.

Step 480: if the obtained traffic is smaller than minimum of the traffic that stored in said traffic queue, randomly replacing the minimum traffic with the obtained traffic or eliminating the obtained traffic in equal probability; if the obtained traffic is more than maximum of the traffic that stored in said traffic queue, randomly replacing the maximum traffic with the obtained traffic or deleting the obtained traffic in equal probability.

Step 490: confirming that the updated location of the obtained traffic in the traffic queue based a magnitude comparison between the obtained traffic and the traffics stored in the traffic queue.

Step 500: writing the obtained traffic into the updated location, in order to lengthen traffic queue; after that, the traffic of the traffic queue may be arranged orderly.

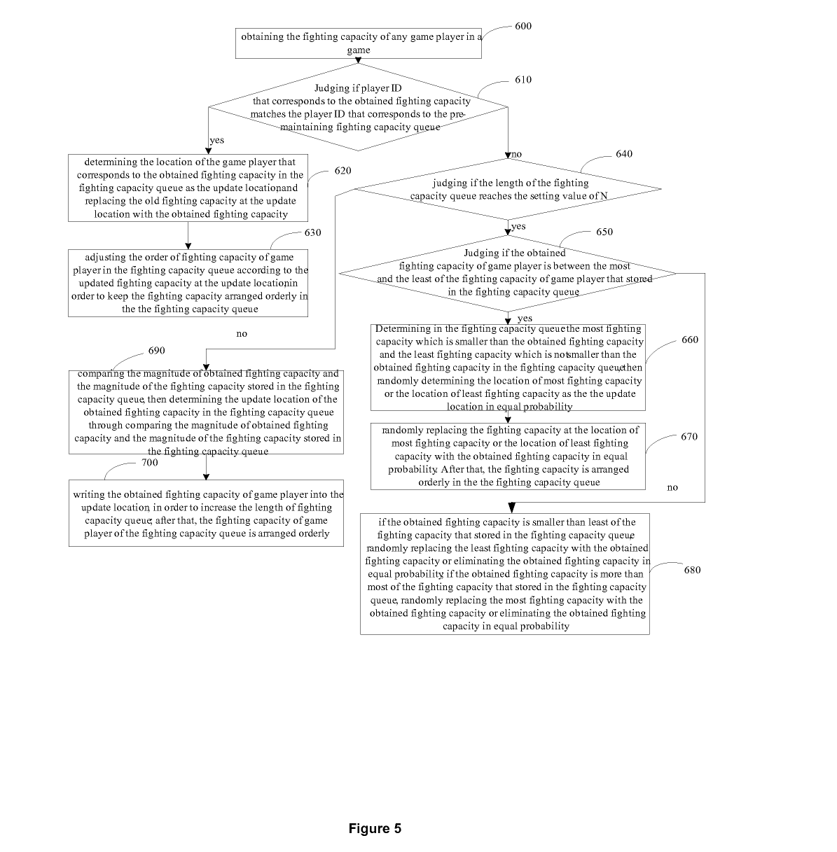

Another implementation of the method for obtaining the dynamic distributed data of sample attributes provided by this disclosure may be illustrated by an example involving on-line game players, as illustrated in FIG. 5.

More specifically, FIG. 5 illustrates a flowchart of an exemplary method for obtaining dynamic distributed data of sample attributes in on-line game playing, wherein the sample attribute may be the fighting capacity or resource, any one sample may be a player ID (i.e., an on-line game player), a pool of large scale data may be the game players playing the same on-line game, and the sample attribute queue may be the fighting capacity queue. The method may include the following exemplary steps.

Step 600: obtaining the fighting capacity of any game player in a game. Game players in a game mode each has a corresponding fighting capacity, where changes to their respective fighting capacity in the game mode may be sent to the server. Fighting capacity data of each game player corresponding to a player ID may be uploaded to the server.

Step 610: determining if player ID corresponding to the obtained fighting capacity matches the player ID corresponding to the priorly-maintained fighting capacity queue, if the result may be yes, then executing step 620, if the result may be no, then executing step 640.

Wherein, the fighting capacity queue may store the fighting capacity of each game player, and the length of the fighting capacity queue may be set to a value N, which may be smaller than the total number of the game players in this game. The fighting capacity of each game player may be orderly arranged in the fighting capacity queue from the most to the least or vice versa.

Preferably, the fighting capacity queue may store the game player fighting capacity of each game player corresponding to the player ID. One may compare to match the player ID stored in the fighting capacity queue with the player ID of the obtained fighting capacity of game player, if a match is found, it may be certain that the game player corresponding to the obtained fighting capacity of game player matches the game player corresponding to the priorly-maintained fighting capacity queue, which may mean that there may be an old fighting capacity stored in the fighting capacity queue for the corresponding game player of obtained fighting capacity. If the match cannot be found, then the game player corresponding to the obtained fighting capacity does not match the game player corresponding to the priorly-maintained fighting capacity queue, which may mean that there may be not an old fighting capacity stored in the fighting capacity queue for the corresponding sample of obtained fighting capacity.

In an embodiment, the server may set a hash map having a key corresponding to the player ID. The hash map may be used to locate the fighting capacity in the fighting capacity queue. It may be able to judge if the player ID corresponding to the obtained fighting capacity matches the player ID corresponding to the priorly-maintained fighting capacity queue through matching to the corresponding player ID of the obtained fighting capacity in the hash map.

Step 620: determining the location of the game player corresponding to the obtained fighting capacity in the fighting capacity queue as the updated location, and replacing the old fighting capacity at the updated location with the obtained fighting capacity.

It may be worth noting that, while replacing the old fighting capacity with the obtained fighting capacity at the updated location, this embodiment may also replace the corresponding old player ID with the corresponding player ID of obtained fighting capacity at the updated location.

Step 630: adjusting the order of fighting capacity of game player in the fighting capacity queue according to the updated fighting capacity at the updated location, in order to keep the fighting capacity orderly arranged in the fighting capacity queue.

Step 640: determining if a length of the fighting capacity queue reaches the set value of N; if the result may be yes, then executing step 650, if the result may be no, then executing step 690.

Step 650: determining if the obtained fighting capacity of game player may lie between the most and the least of the fighting capacity of game player that stored in the fighting capacity queue; if the result may be yes, then executing step 460, if the result may be no, then executing step 480.

Step 660: determining the most fighting capacity which may be less than the obtained fighting capacity and the least fighting capacity which may be not be less than the obtained fighting capacity in the fighting capacity queue, then randomly in equal opportunity, determining the location of the most fighting capacity or the location of the least fighting capacity as the updated location in equal probability.

Step 670: randomly in equal opportunity, replacing the fighting capacity at the location of the most fighting capacity or the location of the least fighting capacity with the obtained fighting capacity. After that, the fighting capacity may be orderly arranged in the fighting capacity queue.

It may be worth noting that, while replacing the old fighting capacity with the obtained fighting capacity at the updated location, this embodiment may also replace the corresponding old player ID with the corresponding player ID of obtained fighting capacity at the updated location.

Step 680: if the obtained fighting capacity may be smaller than the least of the fighting capacity that is stored in the fighting capacity queue, randomly in equal opportunity, replacing the least fighting capacity with the obtained fighting capacity or deleting the obtained fighting capacity. If the obtained fighting capacity may be more than the most of the fighting capacity that is stored in the fighting capacity queue, randomly in equal opportunity, replacing the most fighting capacity with the obtained fighting capacity or deleting the obtained fighting capacity in equal probability.

Step 690: comparing a magnitude of the obtained fighting capacity and the magnitude of the fighting capacity stored in the fighting capacity queue, then determining the updated location of the obtained fighting capacity in the fighting capacity queue through comparing the magnitude of obtained fighting capacity and the magnitude of the fighting capacity stored in the fighting capacity queue.

Step 700: writing the obtained fighting capacity of game player into the updated location, in order to lengthen fighting capacity queue; after that, the fighting capacity of game player of the fighting capacity queue may be arranged orderly. It may be worth noting that, while writing the obtained fighting capacity into the updated location, this embodiment may also write the player ID of the obtained fighting capacity into the updated location.

Combination with step 620, 630,670, and step 700 as shown in the FIG. 5, the dynamic distributed data of players' fighting capacity may be obtained. In this embodiment, the fighting capacity queue may reflect the fighting capacity distribution in the game.

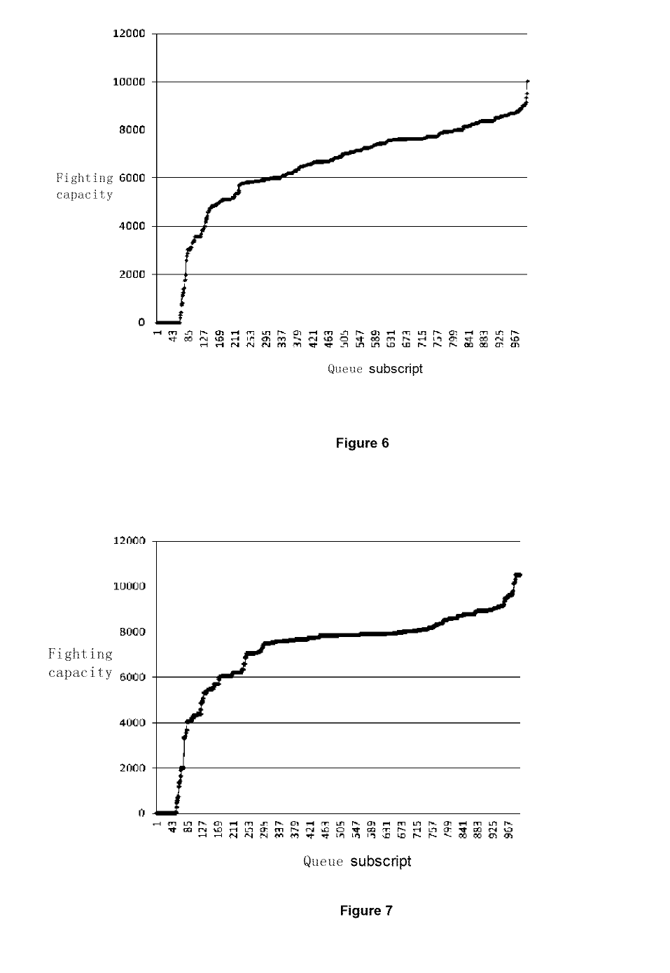

FIGS. 6 and 7 respectively illustrate data graphs of the on-line game players' fighting capacity queue in an on-line game at different time. The length of the players' fighting capacity queue maintained by the server may be set at 1000 in the figures for illustration. There may be more than 300 players who are playing the game online at any given time, so the curve may be not appear as smooth. By inspection of both FIGS. 6 and 7, it may be shown that most on-line game players' fighting capacity may be in an increasing trend.

A system for obtaining the dynamic distributed data of sample attributes that present embodiment provides may be described. The system and the method described may be cross-referenced.

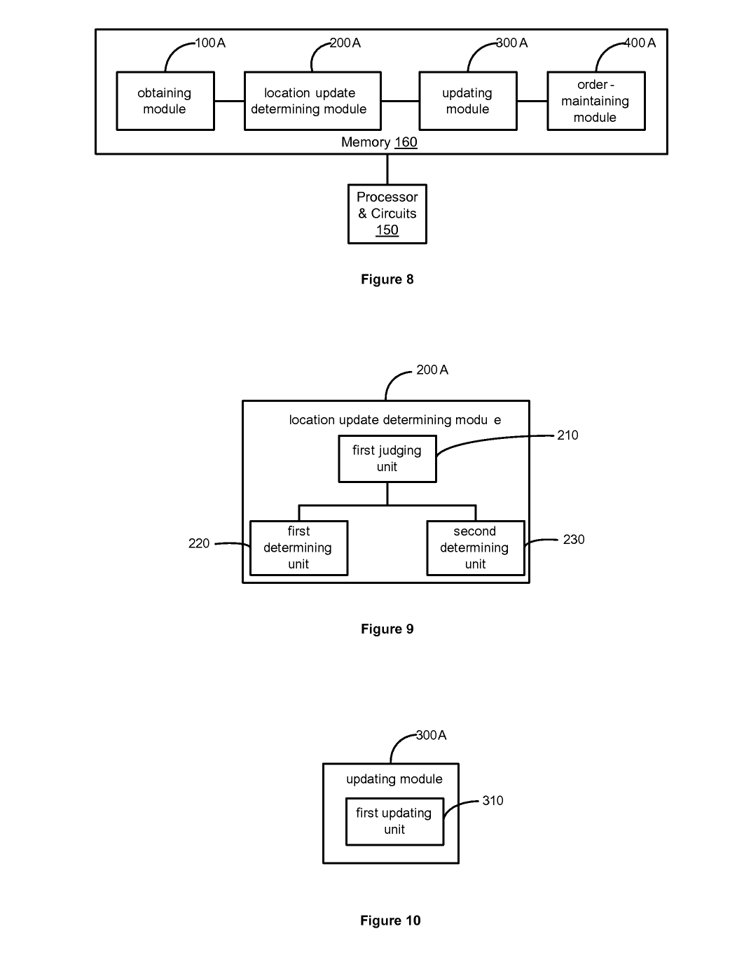

FIG. 8 illustrates an exemplary system for obtaining dynamic distributed data of sample attributes, according to an embodiment of the present disclosure. The system may include at least: a processor with circuitry (150) operating in conjunction with at least a memory (160) which stores instruction codes operable as plurality of modules, wherein the plurality of modules may include: an obtaining module (100A), a location update determining module (200A), an update module (300A), an order maintaining module (400A).

The obtaining module (100A) obtains a sample attribute from any one sample out of a pool of large-scale samples. The location update determining module (200A) determines an updated location of where the obtained sample attribute may be located within a priorly-maintained sample attribute queue. The updating module (300A) updates at the updated location utilizing the obtained sample attribute.

The order-maintaining module (400A) maintains an orderly arrangement of the sample attributes in the sample attribute queue, in order to obtain dynamic distributed data of the obtained sample attributes, wherein: the sample attribute queue stores the sample attributes of the pool of large-scale samples, the sample attributes are orderly arranged in the sample attribute queue; a length of the sample attribute queue may be set at a value of N, wherein the value N may be smaller than a total number of the samples in the pool of large-scale samples.

FIG. 9 shows an exemplary structure of a location update determining module (200A), which may include a first judging unit (210), a first determining unit (220) and a second determining unit (230).

The first judging unit (210) determines if the one sample corresponding to the obtained sample attribute matches to a sample corresponding to the sample attribute queue. If it may be determined that the one sample corresponding to the obtained sample attribute matches to a sample corresponding to the sample attribute queue, the first determining unit (220) confirms that the location of the one sample corresponding to the obtained sample attribute being the updated location within the sample attribute queue. If it may be determined that the one sample corresponding to the obtained sample attribute does not match to a sample corresponding to the sample attribute queue, the second determining unit (230) determines the updated location of the obtained sample attribute by comparing a magnitude of the obtained sample attribute to each magnitude of the sample attributes stored in the sample attribute queue.

FIG. 10 shows an exemplary structure of the updating module (300A), which may include a first updating unit (310) which replaces sample attribute corresponding to the updated location within the sample attribute queue with the obtained sample attribute.

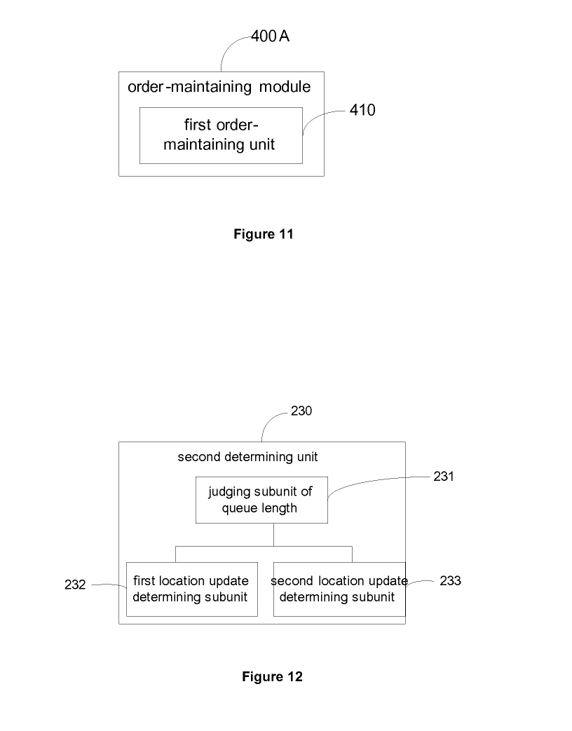

FIG. 11 shows an exemplary structure of the order-maintaining module (400A), which includes a first order-maintaining unit (410) which adjusts an order of the sample attributes arranged in the sample attribute queue according to the sample attribute updated in the updated location, in order to keep the orderly arrangement of the sample attributes in the sample attribute queue.

FIG. 12 shows an exemplary structure of the second determining unit (230), which includes a determining subunit of queue length (231), a first location update determining subunit (232) and a second location update determining subunit (233).

The determining subunit of queue length (231) determines whether the length of the sample attribute queue reaches the set value of N.

Wherein when a judgment result of the determining subunit of queue length determines that the length of the sample attribute queue reaches the set value of N, and if the obtained sample attribute lies between a maximum value and a minimum value of the sample attributes stored in the sample attribute queue, the first location update determining subunit (232) determines that if the sample attributes stored in the sample attribute queue: the biggest sample attribute being less than the obtained sample attribute, but the smallest sample attribute being no less than the obtained sample attribute, then randomly in equal probability, confirms that the updated location as being one of: a location of the biggest sample attribute or the smallest sample attribute.

When the judgment result of the determining subunit of queue length determines that the length of the sample attribute queue fails to reach the set value of N: the second location update determining subunit (233) confirms that the updated location of the obtained sample attribute in the sample attribute queue based a magnitude comparison between the obtained sample attribute and the sample attributes stored in the sample attribute queue.

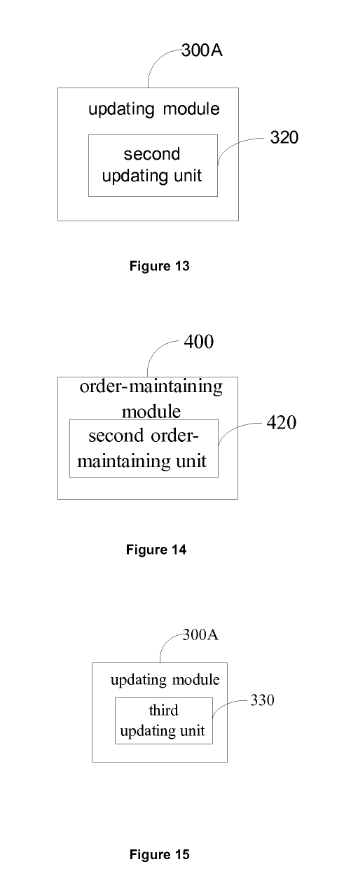

FIG. 13 shows an exemplary structure of the updating module (300A), which includes a second updating unit (320) which randomly in equal opportunity determines the location of the biggest sample attribute or the location of the smallest sample attribute as the updated location, when the first determining subunit (232) of updated location determines the updated location.

FIG. 14 shows an exemplary structure of the order-maintaining module (400), which may include a second order-maintaining unit (420) which determines the sample attribute of the sample attribute queue arranged orderly after randomly in equal opportunity, replacing sample attribute which may be at a location corresponding to the biggest sample attribute or corresponds to smallest sample attribute with the obtained sample attribute.

FIG. 15 shows an exemplary structure of the updating module (300A), which may include a third updating unit (330) which writes the obtained sample attribute into the updated location in order to lengthen the sample attribute queue, when the second determining subunit (233) of updated location determines the updated location.

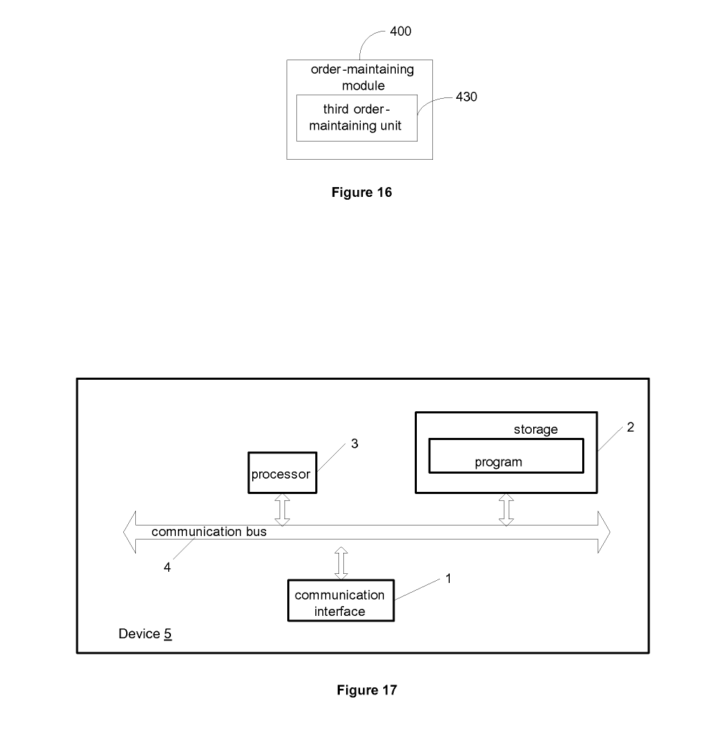

FIG. 16 shows an exemplary structure of the order-maintaining module (400), which may include a third order-maintaining unit (430) which determines the sample attribute of the sample attribute queue arranged orderly after writing the obtained sample attribute into the updated location.

FIG. 17 shows an exemplary hardware structure of a server (5), according to one embodiment of the present disclosure. The server may include a communication interface (1), at least a storage (2), a processor circuitry (3), and a communication bus (4).

The communication interface (1) may be the interface of communication module, such as interface of network card which receives and sends signals in the process of the server sending and receiving information with other external devices.

The at least one storage (2) may store software programs and modules. The processor circuitry (3) may execute the functions of the server (5) and data processing by running the software programs and modules stored in the storage (2). The storage (2) mainly includes procedures store and data store, wherein, the procedures store may store the operating system, at least one required application (such as voice broadcast function and image display function, etc.) and so on. In addition storage (2) may also include high speed random access memory and nonvolatile memory, such as at least one disk storage devices, flash memory devices, or other volatile solid storage devices.

The processor circuitry (3) may be the control center of server whose parts are connected by various interfaces and lines. The processor circuitry (3) may execute various functions of server and data processing by running the software programs and/or modules stored in the storage (2) and calling the data stored in the storage (2) to monitor the server (5). Preferably, the processor circuitry (3) may include one or more processing unit. Optimally, the processor circuitry (3) may integrate the application processor and modem processor, wherein, the application processor mainly deals with operating system and application etc., and the modem processor mainly deals with smaller communication. It may be understood that the modem processor may not be integrated into the processor circuitry (3).

The interface (1), storage (2), processor circuitry (3) complete the communication between each other through the communication bus (4).

As shown in the above disclosure, contrast to the existing technology which requires traversing the database and reading all the sample attributes in the database, the embodiments of the disclosed method and system are based on the simple random sampling principle, which the method and the system may obtain dynamic distributed data of the sample attributes, as long as the sample attribute queue may maintain at least a length of N. The present disclosed method thereby reduces the requirement of calculating all the sample attributes in the database to obtain the dynamic distributed data of the sample attributes.

It should be understood by those with ordinary skill in the art that all or some of steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory.

The foregoing represents only some preferred embodiments of the present disclosure and their disclosure may not be construed to limit the present disclosure in any way. Those of ordinary skill in the art may recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. A method for obtaining dynamic distributed data of sample attributes, comprising:
obtaining a sample attribute from any one sample out of a pool of large-scale samples;
determining an updated location of where the obtained sample attribute is located within a priorly-maintained sample attribute queue, and performing updating at the updated location utilizing the obtained sample attribute; and
maintaining an orderly arrangement of the sample attributes in the sample attribute queue, in order to obtain dynamic distributed data of the obtained sample attributes, wherein:
the sample attribute queue stores the sample attributes of the pool of large-scale samples,
the sample attributes are orderly arranged in the sample attribute queue; and
a length of the sample attribute queue is set at a value of N, wherein the value N being smaller than a total number of the samples in the pool of large-scale samples.

2. The method according to claim 1, wherein the determining of the updated location of where the obtained sample attribute is located within the priorly-maintained sample attribute queue, comprises:
determining if the one sample corresponding to the obtained sample attribute matches to a sample corresponding to the sample attribute queue;
if it is determined that the one sample corresponding to the obtained sample attribute matches to the sample corresponding to the sample attribute queue, confirming that the location of the one sample corresponding to the obtained sample attribute being the updated location within the sample attribute queue;
otherwise, determining the updated location of the obtained sample attribute by comparing a magnitude of the obtained sample attribute to each magnitude of the sample attributes stored in the sample attribute queue.

3. The method according to claim 2, wherein when the one sample corresponding to the obtained sample attribute matches the sample corresponding to the sample attribute queue, the updating at the updated location utilizing the obtained sample attribute, comprises:
replacing sample attribute corresponding to the updated location within the sample attribute queue with the obtained sample attribute;
wherein the maintaining of the orderly arrangement of the sample attributes in the sample attribute queue, comprising:
adjusting an order of the sample attributes arranged in the sample attribute queue according to an updated sample attribute in the updated location, in order to keep the orderly arrangement of the sample attributes in the sample attribute queue.

4. The method according to claim 2, wherein the determining of the updated location of the obtained sample attribute by comparing the magnitude of the obtained sample attribute to each magnitude of the sample attributes stored in the sample attribute queue, comprises:
determining whether the length of the sample attribute queue reaches the set value of N:
if the length of the sample attribute queue reaches the set value of N, and if the obtained sample attribute lies between a maximum value and a minimum value of the sample attributes stored in the sample attribute queue:
determining that if the sample attributes stored in the sample attribute queue: the biggest sample attribute being less than the obtained sample attribute, and the smallest sample attribute is no less than the obtained sample attribute, then randomly in equal probability, confirming that the updated location as being one of: a location of the biggest sample attribute or the smallest sample attribute;
if the length of the sample attribute queue reaches the set value of N, and if the obtained sample attribute being smaller than the smallest sample attributes stored in the sample attribute queue, then randomly in equal opportunity, performing one of: replacing the smallest sample attribute with the obtained sample attribute, otherwise, deleting the obtained sample attribute;
if the length of the sample attribute queue reaches the set value of N, and if the obtained sample attribute being greater than the biggest sample attributes stored in the sample attribute queue, then randomly in equal opportunity, performing one of: confirming that a location of the sample attributes with the maximum value as the updated location, otherwise, deleting the obtained sample attribute; and
if the length of the sample attribute queue fails to reach the set value of N, then confirming that the updated location of the obtained sample attribute in the sample attribute queue based a magnitude comparison between the obtained sample attribute and the sample attributes stored in the sample attribute queue.

5. The method according to claim 4, wherein if the length of the sample attribute queue reaches the set value of N, and if the obtained sample attribute lies between a maximum value and a minimum value of the sample attributes stored in the sample attribute queue, the updating at the updated location utilizing the obtained sample attribute, comprises:
randomly in equal opportunity, replacing the sample attribute which is at a location corresponding to one of: the biggest sample attribute or the smallest sample attribute with the obtained sample attribute;
wherein the maintaining of the orderly arrangement of the sample attributes in the sample attribute queue, comprising:
confirming that the sample attributes in the sample attribute queue being orderly arranged, after randomly replacing the sample attribute which is at the location corresponding to one of: the biggest sample attribute or the smallest sample attribute with the obtained sample attribute.

6. The method according to claim 4, wherein if the length of the sample attribute queue fails to reach the set value of N, the updating at the updated location utilizing the obtained sample attribute, comprises:
writing the obtained sample attribute into the updated location in order to lengthen the sample attribute queue;
wherein the maintaining of the orderly arrangement of the sample attributes in the sample attribute queue, comprising:
confirming that the sample attributes in the sample attribute queue being arranged orderly, after the writing of the obtained sample attribute into the updated location.

7. A system for obtaining dynamic distributed data of sample attributes, comprising at least a processor with circuitry operating in conjunction with at least a memory which stores instruction codes operable as plurality of modules, wherein the plurality of modules comprise:
an obtaining module which obtains a sample attribute from any one sample out of a pool of large-scale samples;
a location update determining module, which determines an updated location of where the obtained sample attribute may be located within a priorly-maintained sample attribute queue;
an updating module which updates at the updated location utilizing the obtained sample attribute; and
an order-maintaining module which maintains an orderly arrangement of the sample attributes in the sample attribute queue, in order to obtain dynamic distributed data of the obtained sample attributes, wherein:
the sample attribute queue stores the sample attributes of the pool of large-scale samples,
the sample attributes are orderly arranged in the sample attribute queue;
a length of the sample attribute queue may be set at a value of N, wherein the value N may be smaller than a total number of the samples in the pool of large-scale samples.

8. The system according to claim 7, wherein the location update determining module comprises:
a first judging unit which determines if the one sample corresponding to the obtained sample attribute matches to a sample corresponding to the sample attribute queue;
if it is determined that the one sample corresponding to the obtained sample attribute matches to a sample corresponding to the sample attribute queue, a first determining unit confirms that the location of the one sample corresponding to the obtained sample attribute being the updated location within the sample attribute queue; and
if it is determined that the one sample corresponding to the obtained sample attribute does not match to a sample corresponding to the sample attribute queue, a second determining unit which determines the updated location of the obtained sample attribute by comparing a magnitude of the obtained sample attribute to each magnitude of the sample attributes stored in the sample attribute queue.

9. The system according to claim 8, wherein when the first judging unit determines that the location of sample which corresponds to the obtained sample attribute being the updated location, the updating module comprises:
a first updating unit replaces sample attribute corresponding to the updated location within the sample attribute queue with the obtained sample attribute;
wherein the order-maintaining module includes:
a first order-maintaining unit which adjusts an order of the sample attributes arranged in the sample attribute queue according to the sample attribute updated in the updated location, in order to keep the orderly arrangement of the sample attributes in the sample attribute queue.

10. The system according to claim 8, wherein the second determining unit includes:
a determining subunit of queue length which determines whether the length of the sample attribute queue reaches the set value of N, wherein:
a first location update determining subunit, wherein when a judgment result of the determining subunit of queue length determines that the length of the sample attribute queue reaches the set value of N, and if the obtained sample attribute lies between a maximum value and a minimum value of the sample attributes stored in the sample attribute queue:
the first location update determining subunit determines that if the sample attributes stored in the sample attribute queue: the biggest sample attribute being less than the obtained sample attribute, and the smallest sample attribute is no less than the obtained sample attribute, then randomly in equal probability, confirms that the updated location as being one of: a location of the biggest sample attribute or the smallest sample attribute;
a second location update determining subunit, wherein when the judgment result of the determining subunit of queue length determines that the length of the sample attribute queue fails to reach the set value of N:
the second location update determining subunit confirms that the updated location of the obtained sample attribute in the sample attribute queue based a magnitude comparison between the obtained sample attribute and the sample attributes stored in the sample attribute queue.

11. The system according to claim 10, wherein:
the updating module comprises:
a second updating unit, the order-maintaining module comprises a second order-maintaining unit, in a condition of the updated location being determined by the first location update determining subunit;
a third updating unit, the order-maintaining module comprises a third order-maintaining unit, in a condition of the updated location being determined by the second location update determining subunit;
wherein after the updated location may be determined by the first location update determining subunit, the second updating unit randomly in equal probability, confirms that the updated location as being one of: a location of the biggest sample attribute or the smallest sample attribute;
the second order-maintaining unit confirms that the sample attributes in the sample attribute queue being arranged orderly, after randomly replacing the sample attribute which may be at the location corresponding to one of: the biggest sample attribute or the smallest sample attribute with the obtained sample attribute;
the third updating unit writes the obtained sample attribute into the updated location, in order to lengthen the sample attribute queue after the updated location may be determined by the second location update determining subunit; and
the third order-maintaining unit confirms that the sample attributes in the sample attribute queue being arranged orderly, after the writing of the obtained sample attribute into the updated location.

12. A non-transitory computer readable storage medium, wherein the computer readable storage medium stores a program which comprises codes or instructions to cause a machine to perform operations to obtain dynamic distributed data of sample attributes, the operations comprising:
obtaining a sample attribute from any one sample out of a pool of large-scale samples;
determining an updated location of where the obtained sample attribute is located within a priorly-maintained sample attribute queue, and then performing updating at the updated location utilizing the obtained sample attribute;
maintaining an orderly arrangement of the sample attributes in the sample attribute queue, in order to obtain dynamic distributed data of the obtained sample attributes, wherein:
the sample attribute queue stores the sample attributes of the pool of large-scale samples,
the sample attributes are orderly arranged in the sample attribute queue;
a length of the sample attribute queue is set at a value of N, wherein the value N being smaller than a total number of the samples in the pool of large-scale samples.

13. The non-transitory computer readable storage medium according to claim 12, wherein the determining of the updated location of where the obtained sample attribute is located within the priorly-maintained sample attribute queue, comprising:
determining if the one sample corresponding to the obtained sample attribute matches to a sample corresponding to the sample attribute queue;
if it is determined that the one sample corresponding to the obtained sample attribute matches to a sample corresponding to the sample attribute queue, confirming that the location of the one sample corresponding to the obtained sample attribute being the updated location within the sample attribute queue;
otherwise, determining the updated location of the obtained sample attribute by comparing a magnitude of the obtained sample attribute to each magnitude of the sample attributes stored in the sample attribute queue.

14. The non-transitory computer readable storage medium according to claim 13, wherein when the one sample corresponding to the obtained sample attribute matches the sample corresponding to the sample attribute queue, the updating at the updated location utilizing the obtained sample attribute, comprising:
replacing sample attribute corresponding to the updated location within the sample attribute queue with the obtained sample attribute;
wherein the maintaining of the orderly arrangement of the sample attributes in the sample attribute queue, comprising:
adjusting an order of the sample attributes arranged in the sample attribute queue according to the sample attribute updated in the updated location, in order to keep the orderly arrangement of the sample attributes in the sample attribute queue.

15. The non-transitory computer readable storage medium according to claim 13, wherein the determining of the updated location of the obtained sample attribute by comparing the magnitude of the obtained sample attribute to each magnitude of the sample attributes stored in the sample attribute queue, comprising:
determining whether the length of the sample attribute queue reaches the set value of N:
if the length of the sample attribute queue reaches the set value of N, and if the obtained sample attribute lies between a maximum value and a minimum value of the sample attributes stored in the sample attribute queue:
determining that if the sample attributes stored in the sample attribute queue: the biggest sample attribute being less than the obtained sample attribute, and the smallest sample attribute is no less than the obtained sample attribute, then randomly in equal probability, confirming that the updated location as being one of: a location of the biggest sample attribute or the smallest sample attribute;
if the length of the sample attribute queue reaches the set value of N, and if the obtained sample attribute being smaller than the smallest sample attributes stored in the sample attribute queue, then randomly in equal opportunity, performing one of: replacing the smallest sample attribute with the obtained sample attribute, otherwise, deleting the obtained sample attribute;
if the length of the sample attribute queue reaches the set value of N, and if the obtained sample attribute being greater than the biggest sample attributes stored in the sample attribute queue, then randomly in equal opportunity, performing one of: confirming that a location of the sample attributes with the maximum value as the updated location, otherwise, deleting the obtained sample attribute;
if the length of the sample attribute queue fails to reach the set value of N, then confirming that the updated location of the obtained sample attribute in the sample attribute queue based a magnitude comparison between the obtained sample attribute and the sample attributes stored in the sample attribute queue.

16. The non-transitory computer readable storage medium according to claim 15, wherein if the length of the sample attribute queue reaches the set value of N, and if the obtained sample attribute lies between a maximum value and a minimum value of the sample attributes stored in the sample attribute queue, the updating at the updated location utilizing the obtained sample attribute, comprising:
randomly in equal opportunity, replacing the sample attribute which is at a location corresponding to one of: the biggest sample attribute or the smallest sample attribute with the obtained sample attribute;
wherein the maintaining of the orderly arrangement of the sample attributes in the sample attribute queue, comprising:
confirming that the sample attributes in the sample attribute queue being arranged orderly, after randomly replacing the sample attribute which is at the location corresponding to one of: the biggest sample attribute or the smallest sample attribute with the obtained sample attribute.

17. The non-transitory computer readable storage medium according to claim 15, wherein if the length of the sample attribute queue fails to reach the set value of N, the updating at the updated location utilizing the obtained sample attribute, comprising:
writing the obtained sample attribute into the updated location, in order to lengthen the sample attribute queue;
wherein the maintaining of the orderly arrangement of the sample attributes in the sample attribute queue, comprising:
confirming that the sample attributes in the sample attribute queue being arranged orderly, after the writing of the obtained sample attribute into the updated location.
